(19) United States
(12) Patent Application Publication
(10) Pub. No.: US 2019/0147470 A1
(43) Pub. Date: May 16, 2019

(54) INFORMATION PROCESSING APPARATUS AND INFORMATION PROCESSING METHOD

(71) Applicant: YAHOO JAPAN CORPORATION, Tokyo (JP)

(72) Inventors: Yosuke SHIRAISHI, Tokyo (JP); Tomohito TAKUSARI, Tokyo (JP); Kotaro UEMURA, Tokyo (JP); Atsushi HOSODA, Tokyo (JP)

(73) Assignee: YAHOO JAPAN CORPORATION, Tokyo (JP)

(21) Appl. No.: 16/118,023

(22) Filed: Aug. 30, 2018

(30) Foreign Application Priority Data
Nov. 14, 2017 (JP) 2017-219474
Jan. 31, 2018 (JP) 2018-015483

(51) Int. Cl. G06Q 30/02; G06Q 30/06

(52) U.S. Cl. CPC G06Q 30/0206; G06Q 30/0633

(57) ABSTRACT

An information processing apparatus according to the present application includes a reception unit, a decision unit, and a transmitting unit. The reception unit receives from a user terminal an order request, including information on a moving body that makes an on-the-spot sale, for a product to be sold at the on-the-spot sale. The decision unit decides a price of the product in accordance with the information, received by the reception unit, on the moving body. The transmitting unit transmits, to the user terminal, the price decided by the decision unit.

### CROSS-REFERENCE TO RELATED APPLICATION(S)

The present application claims priority to and incorporates by reference the entire contents of Japanese Patent Application No. 2017-219474 filed in Japan on Nov. 14, 2017 and Japanese Patent Application No. 2018-015483 filed in Japan on Jan. 31, 2018.

### BACKGROUND OF THE INVENTION

### 1. Field of the Invention

The present invention relates to an information processing apparatus and an information processing method.

### 2. Description of the Related Art

Conventionally, in an event site and/or a stadium such as a baseball stadium and a soccer stadium, when an ordered product whose received order is transmitted from a portable terminal of a customer is a product that is sold on the spot by a moving body such as a vendor, there has been known a technology for transmitting order information to a moving body of moving bodies that is the closest to an ordering customer (see, e.g., Japanese Patent Application Laid-open No. 2005-174136).

However, the above-mentioned conventional technology is merely for realizing a quick provision of a product to a customer, and an additional service is not always provided to the on-the-spot sale of the product, which is made by the moving body.

### SUMMARY OF THE INVENTION

An information processing apparatus according to an embodiment includes a reception unit, a decision unit, and a transmitting unit. The reception unit receives from a user terminal an order request, including information on a moving body that makes an on-the-spot sale, for a product to be sold at the on-the-spot sale. The decision unit decides a price of the product in accordance with the information, received by the reception unit, on the moving body. The transmitting unit transmits, to the user terminal, the price decided by the decision unit.

### BRIEF DESCRIPTION OF THE DRAWINGS

FIG. 1 is a diagram illustrating one example of information processing according to an embodiment;

FIG. 2 is a diagram illustrating a configuration example of a user terminal according to the embodiment;

FIG. 3 is a diagram illustrating one example of an information processing apparatus according to the embodiment;

FIG. 4 is a diagram illustrating one example of user information that is stored in a user information database according to the embodiment;

FIG. 5 is a diagram illustrating one example of moving-body information that is stored in a moving-body information database according to the embodiment;

FIG. 6 is a diagram illustrating one example of positional information that is stored in a positional information database according to the embodiment;

FIG. 7 is a diagram illustrating one example of time information that is stored in a time information database according to the embodiment;

FIG. 8 is a diagram illustrating one example of count information that is stored in a count information database according to the embodiment;

FIG. 9 is a diagram illustrating one example of popularity information that is stored in a popularity information database according to the embodiment;

FIG. 10 is a diagram illustrating one example of number-of-visitors information that is stored in a number-of-visitors information database according to the embodiment;

FIG. 11 is a diagram illustrating one example of priority information that is stored in a priority information database according to the embodiment;

FIG. 12 is a diagram illustrating one example of game information that is stored in a game information database according to the embodiment;

FIG. 13 is a diagram illustrating one example of sales information that is stored in a sales information database according to the embodiment;

FIG. 14 is a sequence diagram depicting one example of information processing to be executed by an information processing system according to the embodiment;

FIG. 15 is a diagram illustrating one example of a display screen according to a modification of the embodiment; and

FIG. 16 is a diagram illustrating one example of a hardware configuration of a computer that realizes functions of the information processing apparatus.

### DETAILED DESCRIPTION OF THE PREFERRED EMBODIMENTS

Hereinafter, a mode (hereinafter, may be referred to as “embodiment”) for executing an information processing apparatus, an information processing method, and a non-transitory computer-readable recording medium according to the present application will be specifically explained with reference to accompanying drawings. Moreover, an embodiment described below is merely one example, and not intended to limit the information processing apparatus, the information processing method, and the non-transitory computer-readable recording medium according to the present application. Note that in the following embodiment, common parts are represented with same symbols and the description is omitted appropriately.

1. Concept of Information Processing

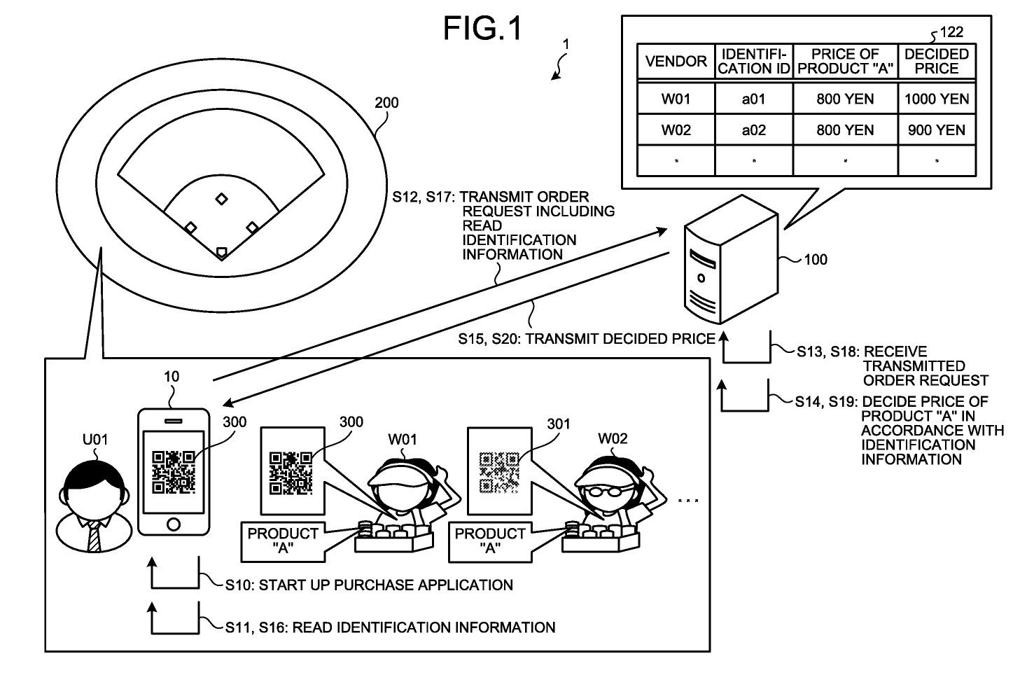

A concept of information processing to be executed by the information processing apparatus will be explained with reference to FIG. 1. FIG. 1 is a diagram illustrating one example of the information processing according to the embodiment. In FIG. 1, a case is indicated in which a user U01 spectating in, for example, an infield stand of a baseball stadium 200 purchases a product A sold on the spot by vendors W01, W02, etc., such as “beer”, by using a user terminal 10 carried by the user U01. In the following description, the “product A” may be referred to as “beer”.

As illustrated in FIG. 1, an information processing system 1 includes the user terminal 10 and an information processing apparatus 100. The user terminal 10 and the information processing apparatus 100 are connected to each other in a wired and/or wireless manner to be able to communicate with each other via a network. The information processing system 1 illustrated in FIG. 1 includes the plurality of user terminals 10.

The user terminal 10 is a terminal device that is used by a user. The user terminal 10 is, for example, a tablet terminal, a Personal Digital Assistant (PDA), a mobile telephone such as a smartphone, or the like.

The information processing apparatus 100 includes information on moving bodies that make on-the-spot sales, receives from the user terminals 10 order requests for product to be sold in the on-the-spot sales, and decides prices of the product in accordance with received information on the respective moving bodies.

Specifically, a moving-body information database 122 of the information processing apparatus 100 stores therein identification identifiers (IDs) that correspond to pieces of identification information that are provided to the respective vendors W01, W02, etc. The moving-body information database 122 stores decided prices that correspond to the respective identification IDs. In the present example, with regard to the vendor W01, an identification ID corresponding to identification information that is provided to the vendor W01 is stored as “a01”, and a “decided price” of the product A, which corresponds to the identification ID “a01”, is stored as “1000 yen”. With regard to the vendor W02, an identification ID corresponding to identification information that is provided to the vendor W02 is stored as “a02”, and a “decided price” of the product A, which corresponds to the identification ID “a02”, is stored as “900 yen”.

As described above, the information processing apparatus 100 according to the embodiment realizes, on the basis of the information stored in the moving-body information database 122, a dynamic decision on a price started from “800 yen”, which is a usual price of the product A, in accordance with the identification information provided to the vendors W01, W02, etc. This mode will be further explained with reference to FIG. 1.

As illustrated in FIG. 1, a case will be explained in which the user U01 purchases “beer” from the vendor W01. The user U01 purchases, by using the user terminal 10, “beer” that is sold on the spot by the vendor W01. Specifically, the user terminal 10 receives, from the user U01, a start-up operation of application that is for performing a purchase process of “beer” (Step S10).

Subsequently, the user terminal 10 reads, by using a camera function provided in the user terminal 10, identification information 300 that is provided to the vendor W01 (Step S11). The identification information may be any of a one-dimensional bar code and a two-dimensional QR code (Registered Trademark). In the present embodiment, the QR code (Registered Trademark) is employed as an example. In this example, the identification information 300 is provided to, but not limited thereto, the vendor W01; however, the identification information 300 may be provided to a trolley, trundled by the vendor W01, for on-the-spot sales.

The user terminal 10 transmits, to the information processing apparatus 100, an order request including the read identification information 300 (Step S12). The information processing apparatus 100 receives the order request transmitted from the user terminal 10 (Step S13).

Subsequently, the information processing apparatus 100 decides, on the basis of information stored in the moving-body information database 122, a price of “beer” in accordance with the identification information 300 included in the received order request (Step S14). Specifically, the information processing apparatus 100 compares the identification information 300 with an “identification ID” of the vendor W01 that is stored in the moving-body information database 122. A “decided price” corresponding to the compared “identification ID (a01)” is “1000 yen”, and thus the information processing apparatus 100 changes the “price of beer” from “800 yen” into “1000 yen” so as to decide the “price of beer” to be sold by the vendor W01 to be “1000 yen”.

Subsequently, the information processing apparatus 100 transmits, to the user terminal 10, the price of “beer” to be sold by the vendor W01, which is decided to be “1000 yen” (Step S15). The user terminal 10 displays the “decided price” of “beer” transmitted from the information processing apparatus 100. In other words, the user terminal 10 displays the fact that the price of “beer” to be sold on the spot by the vendor W01 is “1000 yen”.

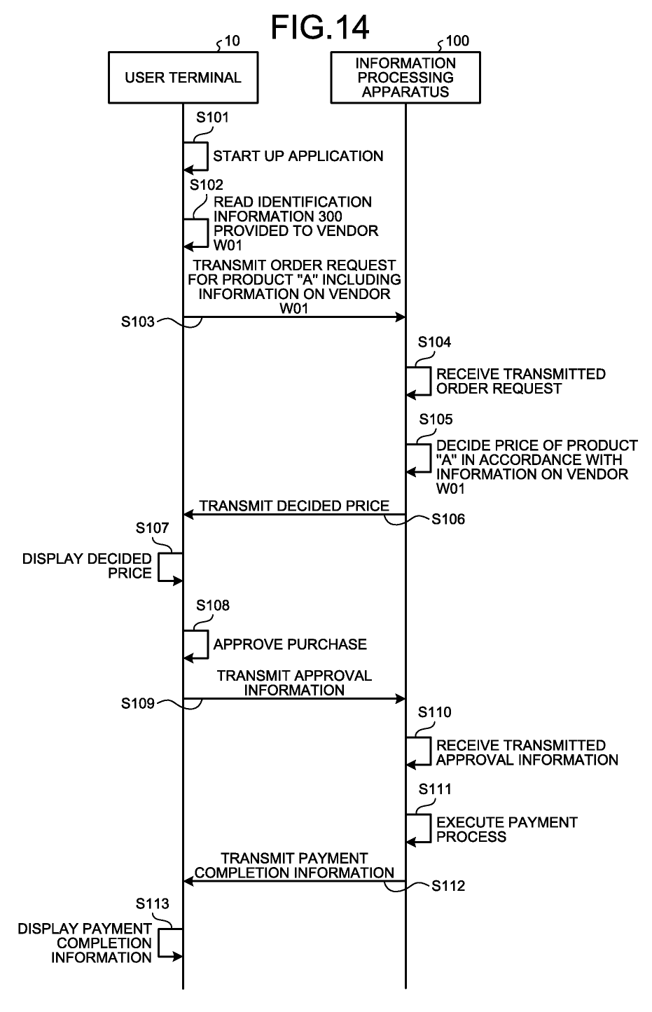

The user U01 recognizes, from the above-mentioned display on the user terminal 10, that the price of “beer” to be sold on the spot by the vendor W01 is “1000 yen”, and performs a purchase operation on the user terminal 10 when he/she is going to purchase it. The purchase operation to be performed on the user terminal 10 will be mentioned later with reference to FIG. 14.

Next, a case will be explained in which the user U01 purchases “beer” from the vendor W02. Assume that the application for executing the purchase process of “beer” has been already started up.

The user terminal 10 reads, by using the camera function provided in the user terminal 10, identification information 301 that is provided to the vendor W02 (Step S16). The user terminal 10 transmits, to the information processing apparatus 100, an order request including the read identification information 301 (Step S17). The information processing apparatus 100 receives the order request transmitted from the user terminal 10 (Step S18).

Subsequently, the information processing apparatus 100 decides, on the basis of information stored in the moving-body information database 122, a price of “beer” in accordance with the identification information 301 included in the received order request (Step S19). Specifically, the information processing apparatus 100 compares the identification information 301 with an “identification ID” of the vendor W02 that is stored in the moving-body information database 122. A “decided price” corresponding to the compared “identification ID (a02)” is “900 yen”, and thus the information processing apparatus 100 changes the “price of beer” from “800 yen” into “900 yen” so as to decide the “price of beer” to be sold by the vendor W02 to be “900 yen”.

Subsequently, the information processing apparatus 100 transmits, to the user terminal 10, the price of “beer” to be sold by the vendor W02, which is decided to be “900 yen” (Step S20). The user terminal 10 displays the “decided price” of “beer” transmitted from the information processing apparatus 100. In other words, the user terminal 10 displays the fact that the price of “beer” to be sold on the spot by the vendor W02 is “900 yen”.

The user U01 recognizes, from the above-mentioned display on the user terminal 10, that the price of “beer” to be sold on the spot by the vendor W02 is “900 yen”, and performs a purchase operation on the user terminal 10 when he/she is going to purchase it.

As described above, the information processing apparatus 100 decides prices of the “product A” in accordance with the information on the vendors W01, W02, etc. even when the “product A” to be sold by the vendors W01, W02, etc. is the same product. Therefore, by employing the information processing apparatus 100, it is possible to provide an additional service to an on-the-spot sale of a product, which is made by a moving body. Thus, it is possible to dynamically decide prices of the product to be sold on the spot by moving bodies such as vendors.

In the example illustrated in FIG. 1, the information processing apparatus 100 changes the “price of beer” from “800 yen” into “1000 yen” so as to decide the “price of beer” to be sold by the vendor W01 to be “1000 yen”, for example; however, the information processing apparatus 100 may simply decide the “price of beer” to be sold by the vendor W01 to be “1000 yen” without changing the price.

In the example illustrated in FIG. 1, the information processing apparatus 100 decides the prices of the “product A” to be sold on the spot by the vendors W01, W02, etc. in accordance with the identification information for identifying the vendors W01, W02, etc. Regarding a decision method of the price, prices of the “product A” to be sold on the spot by the vendors W01, W02, etc. may be decided in accordance with positional information indicating positions of the vendors W01, W02, etc., time point information indicating purchase time points of the “product A”, etc. These various decision methods will be specifically explained in the following embodiment.

2. Configuration Example of User Terminal

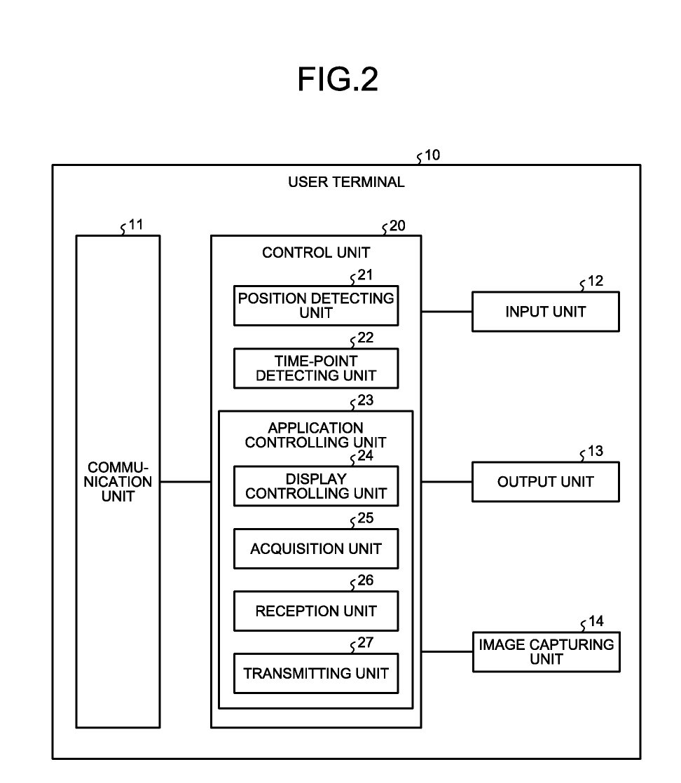

Next, the user terminal 10 according to the embodiment will be explained with reference to FIG. 2. FIG. 2 is a diagram illustrating a configuration example of the user terminal 10 according to the embodiment. As illustrated in FIG. 2, the user terminal 10 includes a communication unit 11, an input unit 12, an output unit 13, an image capturing unit 14, and a control unit 20.

The communication unit 11 is an interface, such as a Network Interface Card (NIC), which communicates with the information processing apparatus 100 connected to a network to be able to communicate with each other.

The input unit 12 is an input device that receives various operations from a user. For example, the input unit 12 is realized by a keyboard, a mouse, operation keys, etc. The output unit 13 is a display for displaying various kinds of information. For example, the output unit 13 is realized by a liquid crystal display, etc. When a touch panel is employed for the user terminal 10, the input unit 12 and the output unit 13 are integrated with each other.

The image capturing unit 14 realizes a camera function for capturing a bar code or a QR code (Registered Trademark). The image capturing unit 14 includes an optical system, such as a lens, and image capturing elements such as a Charge Coupled Device image sensor (CCD image sensor) and a Complementary Metal Oxide Semiconductor sensor (CMOS sensor). The image capturing unit 14 captures, for example, a QR code (Registered Trademark) provided to each of the vendors W01, W02, etc. in response to an operation received from the user via the input unit 12.

The control unit 20 is a controller, and a Central Processing Unit (CPU), a Micro Processing Unit (MPU), or the like executes, by using a RAM as a work region, various programs (corresponding to one example of information processing programs) that are stored in a storage provided in the user terminal 10 so as to realize the control unit 20. The control unit 20 is a controller, for example, and is realized by using an integrated circuit such as an Application Specific Unit (ASIC) and a Field Programmable Gate Array (FPGA).

As illustrated in FIG. 2, the control unit 20 includes a position detecting unit 21, a time-point detecting unit 22, and an application controlling unit 23. The application controlling unit 23 includes a display controlling unit 24, an acquisition unit 25, a reception unit 26, and a transmitting unit 27. The control unit 20 realizes and executes functions and operations of the following information processing. An inner configuration of the control unit 20 is not limited to that illustrated in FIG. 2, and may be another one when the configuration is for executing information processing to be mentioned later.

The position detecting unit 21 detects a present position of the user terminal 10. Specifically, the position detecting unit 21 receives electrical waves transmitted from a global positioning system satellite (GPS satellite), and detects, on the basis of the received electrical waves, positional information (for example, latitude and longitude) that indicates a present position of the user terminal 10.

The time-point detecting unit 22 detects a time point when a product to be sold on the spot by a moving body is purchased. Specifically, the image capturing unit 14 reads a QR code (Registered Trademark) provided to each of the vendors W01, W02, etc., and the time-point detecting unit 22 accordingly detects a time point when a product to be sold on the spot by corresponding one of the vendors W01, W02, etc. is purchased.

The application controlling unit 23 controls application for purchasing a product to be sold on the spot by a moving body, and starts up the application in response to a user operation.

The display controlling unit 24 controls the display of various kinds of information on the output unit 13 in response to various operations received via the input unit 12. Specifically, the display controlling unit 24 causes the output unit 13 to display a decided price obtained by deciding a price of a product in accordance with information on a moving body that is transmitted from the information processing apparatus 100, payment completion information indicating completion of a payment process after purchasing the product, and the like.

The acquisition unit 25 acquires the positional information that indicates the present position of the user terminal 10 detected by the position detecting unit 21. The acquisition unit 25 acquires the time point information that indicates the time point when the product to be sold on the spot by the moving body is purchased, which is detected by the time-point detecting unit 22. The image capturing unit 14 counts reading times of identification information provided to the moving body, and the acquisition unit 25 acquires count information that indicates the number of purchase times of the product with respect to this moving body.

The reception unit 26 receives various kinds of information. For example, the reception unit 26 receives the decided price obtained by deciding the price of the product in accordance with information on the moving body that is transmitted from the information processing apparatus 100, the payment completion information indicating completion of the payment process after purchasing the product, and the like.

The transmitting unit 27 transmits various kinds of information. For example, the transmitting unit 27 transmits, to the information processing apparatus 100, an order request, including information on a moving body to be used for the on-the-spot sale, for the product to be sold by the moving body.

The information on a moving body to be used for the on-the-spot sale includes: the identification information provided to a moving body, which is read by the image capturing unit 14; the positional information that indicates a present position of the user terminal 10, which is detected by the position detecting unit 21; the time point information that indicates a time point when a product to be sold on the spot by a moving body is purchased, which is detected by the time-point detecting unit 22; and the count information that indicates the number of purchase times of a product with respect to a moving body, which is obtained by counting reading times of identification information provided to the moving body by using the image capturing unit 14.

In the present embodiment, the position detecting unit 21 detects positional information, which indicates a present position of the user terminal 10, to be able to determine a position of a moving body that presents near this user terminal 10. In other words, a position of a moving body from which a user is to purchase a product is specified by using positional information that indicates a present position of the user terminal 10 carried by the user, which is detected by the position detecting unit 21.

3. Configuration Example of Information Processing Apparatus

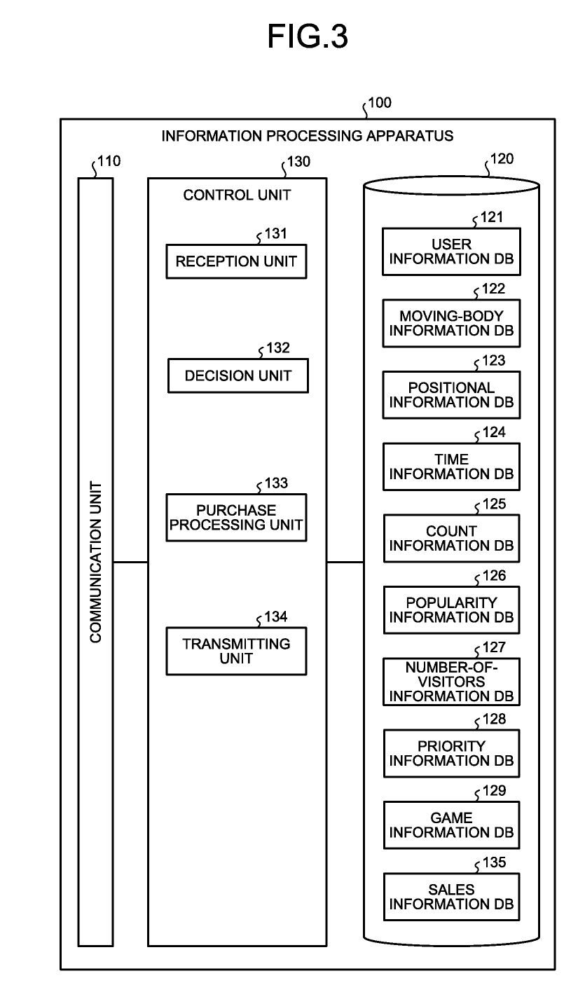

Next, the information processing apparatus 100 according to the embodiment will be explained with reference to FIG. 3. FIG. 3 is a diagram illustrating a configuration example of the information processing apparatus 100 according to the embodiment. As illustrated in FIG. 3, the information processing apparatus 100 includes a communication unit 110, a storage 120, and a control unit 130.

The communication unit 110 is realized by using, for example, an NIC, etc. The communication unit 110 is connected to the network in a wired and/or wireless manner.

The storage 120 is realized by using semiconductor memory elements such as a RAM and a flash memory; or a storage such as a hard disk and an optical disc. As illustrated in FIG. 3, the storage 120 includes a user information database 121, the moving-body information database 122, a positional information database 123, a time information database 124, a count information database 125, a popularity information database 126, a number-of-visitors information database 127, a priority information database 128, a game information database 129, and a sales information database 135.

The user information database 121 is a database that stores various kinds of information on users of the user terminals 10.

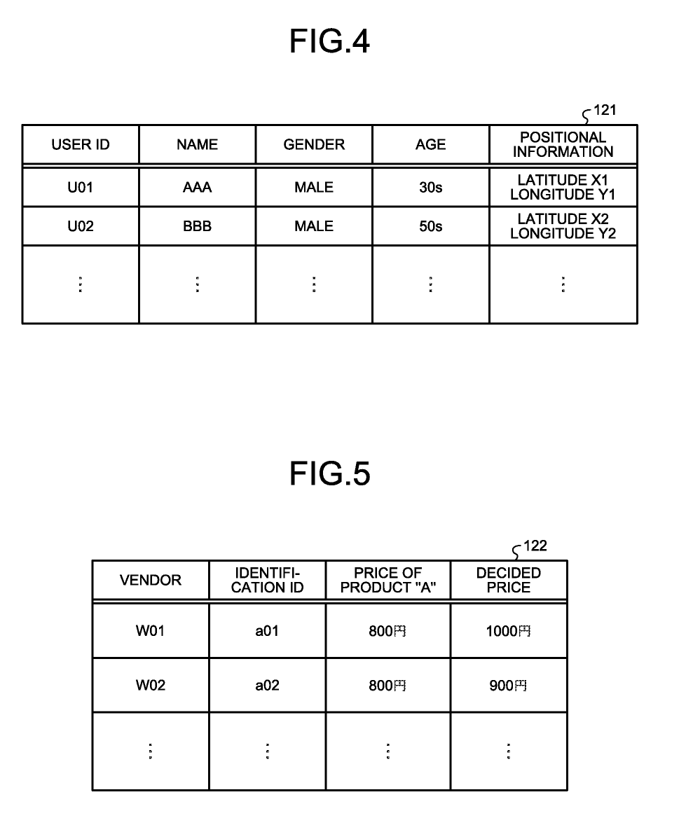

FIG. 4 is a diagram illustrating one example of information that is stored in the user information database 121 according to the embodiment. In the example depicted in FIG. 4, information including items such as “user ID”, “name”, “gender”, “age”, and “positional information” is stored.

The “user ID” is an identifier that indicates a user using the user terminal 10. The “user ID” may be, for example, a cookie ID or an ID that is provided from the information processing apparatus 100 when a user registers him/herself as a member at the information processing apparatus 100 by using the user terminal 10. The “positional information” is information that indicates a position of each of the user terminals 10 (user U01, U02, etc.), which is measured by the corresponding user terminal 10.

For example, in the example illustrated in FIG. 4, the user information database 121 stores therein information of a user ID “U01”, a name “AAA”, a gender “male”, an age “30s”, and positional information “latitude X1 and longitude Y1”.

Such information indicates that the user terminal 10 is used by the user U01 indicated by the user ID “U01” The positional information “latitude X1 and longitude Y1” indicates that a present location of the user U01 is “latitude X1 and longitude Y1”.

The moving-body information database 122 is a database that stores therein various kinds of information on vendors that make on-the-spot sales of a product.

FIG. 5 is a diagram illustrating one example of the moving-body information that is stored in the moving-body information database 122 according to the embodiment. In the example depicted in FIG. 5, information including items such as “vendor”, “identification ID”, “price of product A”, and “decided price” is stored.

The “identification ID” is an identifier that corresponds to identification information provided to each of the vendors W01, W02, etc. In this example, in a state where a vender is the vendor W01, an identification ID corresponding to identification information provided to the vendor W01 is stored as “a01”, and in a state where a vender is the vendor W02, an identification ID corresponding to identification information provided to the vendor W02 is stored as “a02”.

The “decided price” in the moving-body information database 122 is information on a price of the product A that is decided in association with the corresponding identification ID. In this example, a “decided price” of the product A corresponding to the identification ID “a01” is stored as “1000 yen”, and a “decided price” of the product A corresponding to the identification ID “a02” is stored as “900 yen”.

The positional information database 123 is a database that stores therein positional information at which each vendor makes an on-the-spot sale.

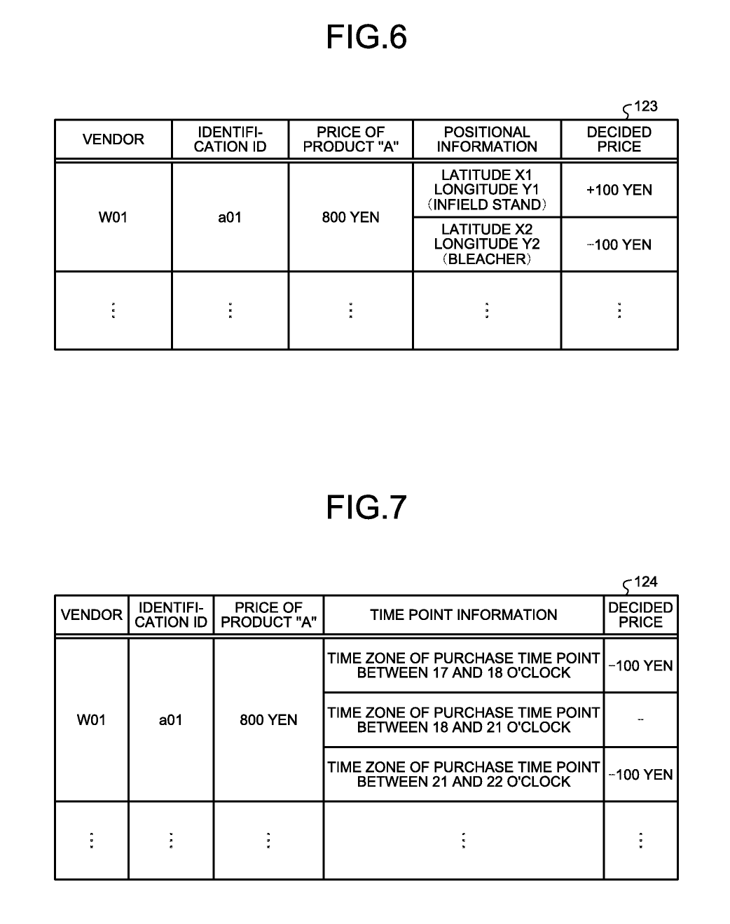

FIG. 6 is a diagram illustrating one example of the positional information that is stored in the positional information database 123 according to the embodiment. In the example depicted in FIG. 6, information including items such as “vendor”, “identification ID”, “price of product A”, “positional information”, and “decided price” is stored.

The “positional information” is information that indicates a position at which each of the vendors W01, W02, etc. makes an on-the-spot sale. The positional information is information that is specified by the positional information detected by the position detecting unit 21 of the user terminal 10.

The “decided price” in the positional information database 123 is information on a price of the product A that is decided in accordance with a position in which each of the vendors W01, W02, etc. makes an on-the-spot sale. For example, when a position in which the vendor W01 makes an on-the-spot sale is an “infield stand” and this position is “latitude X1 and longitude Y1”, a price obtained by adding “100 yen” to the price (“1000 yen”) of the product A to be sold on the spot by the vendor W01, which is decided in association with the identification ID “a01”, is a “decided price”. When a position in which the vendor W01 makes an on-the-spot sale is a “bleacher” and this position is “latitude X2 and longitude Y2”, a price obtained by subtracting “100 yen” from the price (“1000 yen”) of the product A to be sold on the spot by the vendor W01, which is decided in association with the identification ID “a01”, is a “decided price”. Although the “decided price” is exemplified as a price obtained by adding or subtracting a predetermined amount of money to or from a price of the product A to be sold on the spot by the vendor W01, which is decided in association with the identification ID “a01”, the “price of product A” to be sold on the spot by the vendor W01 may be decided, regardless of the price decided in accordance with the identification ID of the vendor W01, by using only a position in which the vendor W01 makes an on-the-spot sale so as to use the decided price as a “decided price”.

The time information database 124 is a database that stores therein time point information indicating a time point when a product to be sold on the spot by each vendor is purchased.

FIG. 7 is a diagram illustrating one example of the time information that is stored in the time information database 124 according to the embodiment. In the example depicted in FIG. 7, information including items such as “vendor”, “identification ID”, “price of product A”, “time point information”, and “decided price” is stored.

The “time point information” is information that indicates a time point when the “product A” is purchased from each of the vendors W01, W02, etc. The time point information is information that is detected by the time-point detecting unit 22 of the user terminal 10 or information that is obtained by measuring a time point when the information processing apparatus 100 receives an order request from the user terminal 10.

The “decided price” of the time information database 124 is information on a price of the product A that is decided in accordance with a time point when the “product A” is purchased from each of the vendors W01, W02, etc. For example, in a case where a time point when the “product A” is purchased from the vendor W01 is within a time zone from 17 o'clock to 18 o'clock, a price obtained by subtracting “100 yen” from the price (“1000 yen”) of the product A to be sold on the spot by the vendor W01, which is decided in association with the identification ID “a01”, is a “decided price”. In a case where a time point when the “product A” is purchased from the vendor W01 is within a time zone from 18 o'clock to 21 o'clock, a price of the product A to be sold on the spot by the vendor W01, which is decided in association with the identification ID “a01”, remains “1000 yen”. For example, in a case where a time point when the “product A” is purchased from the vendor W01 is within a time zone from 21 o'clock to 22 o'clock, a price obtained by subtracting “100 yen” from the price (“1000 yen”) of the product A to be sold on the spot by the vendor W01, which is decided in association with the identification ID “a01”, is a “decided price”. Although the “decided price” is exemplified as a price obtained by adding or subtracting a predetermined amount of money to or from a price of the product A to be sold on the spot by the vendor W01, which is decided in association with the identification ID “a01”, the “price of product A” to be sold on the spot by the vendor W01 may be decided, regardless of the price decided in accordance with the identification ID of the vendor W01, by using only a time point at which the vendor W01 sells the “product A” so as to use the decided price as a “decided price”.

The count information database 125 is a database that stores therein count information indicating a count of purchase times of the product with respect to each vendor.

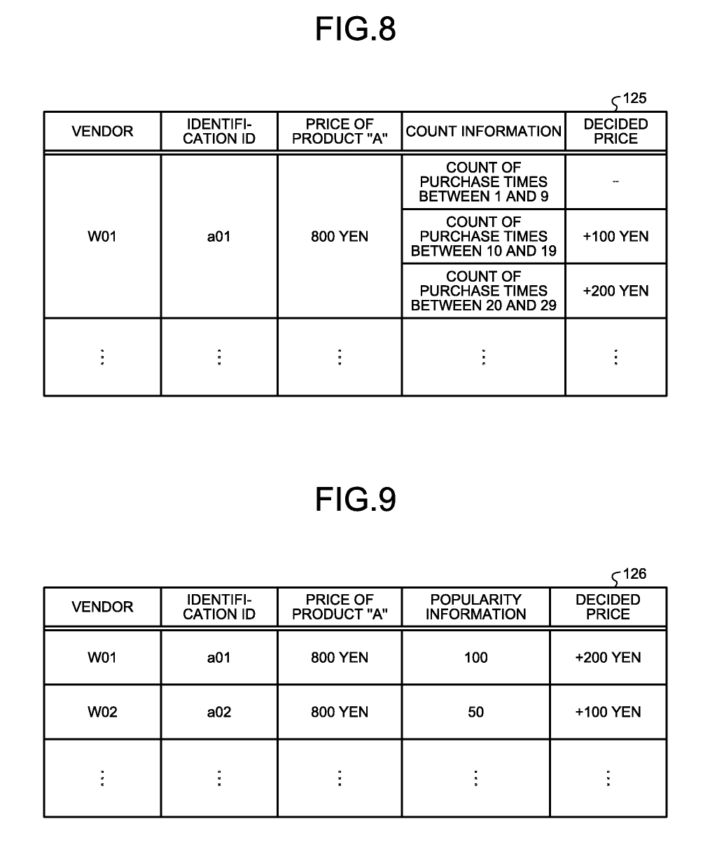

FIG. 8 is a diagram illustrating one example of count information that is stored in the count information database 125 according to the embodiment. In the example depicted in FIG. 8, information including items such as “vendor”, “identification ID”, “price of product A”, “count information”, and “decided price” is stored.

The “count information” is information that indicates a count of purchase times of the “product A” from each of the vendors W01, W02, etc. The count information is information that is obtained by counting reading times of identification information provided to each of the vendors W01, W02, etc. by using the image capturing unit 14 or information obtained by counting reception times of an order request transmitted from the user terminal 10 by using the information processing apparatus 100.

The “decided price” of the count information database 125 is information on a price of the product A that is decided in accordance with a count of purchase times of the “product A” with respect to each of the vendors W01, W02, etc. For example, when a count of purchase times of the “product A” with respect to the vendor W01 is one or more and nine or less, a price of the product A to be sold on the spot by the vendor W01, which is decided in association with the identification ID “a01”, remains “1000 yen”. When the count of purchase times of the “product A” with respect to the vendor W01 is 10 or more and 19 or less, a price obtained by adding “100 yen” to the price (“1000 yen”) of the product A to be sold on the spot by the vendor W01, which is decided in association with the identification ID “a01”, is a “decided price”. When the count of purchase times of the “product A” with respect to the vendor W01 is 20 or more and 29 or less, a price obtained by adding “200 yen” to the price (“1000 yen”) of the product A to be sold on the spot by the vendor W01, which is decided in association with the identification ID “a01”, is a “decided price”. Although the “decided price” is exemplified as a price obtained by adding or subtracting a predetermined amount of money to or from a price of the product A to be sold on the spot by the vendor W01, which is decided in association with the identification ID “a01”, the “price of product A” to be sold on the spot by the vendor W01 may be decided, regardless of the price decided in accordance with the identification ID of the vendor W01, by using only a count of purchase times at each of which the vendor W01 sells the “product A” so as to use the decided price as a “decided price”.

The popularity information database 126 is a database that stores therein information indicating the popularity of each of the vendors W01, W02, etc.

FIG. 9 is a diagram illustrating one example of the popularity information that is stored in the popularity information database 126 according to the embodiment. In the example depicted in FIG. 9, information including items such as “vendor”, “identification ID”, “price of product A”, “popularity information”, and “decided price” is stored.

The “popularity information” is information that indicates the popularity of each of the vendors W01, W02, etc. In this example, an upper limit of the popularity is “100” and a lower limit thereof is “0”. For example, the popularity is decided on the basis of a past sales amount of the product A of each of the vendors W01, W02, etc. The popularity may be decided by using a present actual sales result of the product A instead of the past actual sales result of the product A.

The “decided price” in the popularity information database 126 is information on a price of the product A that is decided in accordance with the popularity of each of the vendors W01, W02, etc. For example, when the user U01 purchases the “product A” from the vendor W01, the popularity of the vendor W01 is “100”, and thus a price obtained by adding “200 yen” to the price (“1000 yen”) of the product A to be sold on the spot by the vendor W01, which is decided in association with the identification ID “a01”, is a “decided price”. When the user U01 purchases the “product A” from the vendor W02, the popularity of the vendor W02 is “50”, and thus a price obtained by adding “100 yen” to the price (“900 yen”) of the product A to be sold on the spot by the vendor W01, which is decided in association with the identification ID “a02”, is a “decided price”.

The number-of-visitors information database 127 is a database that stores therein information indicating the number of visitors to the baseball stadium 200.

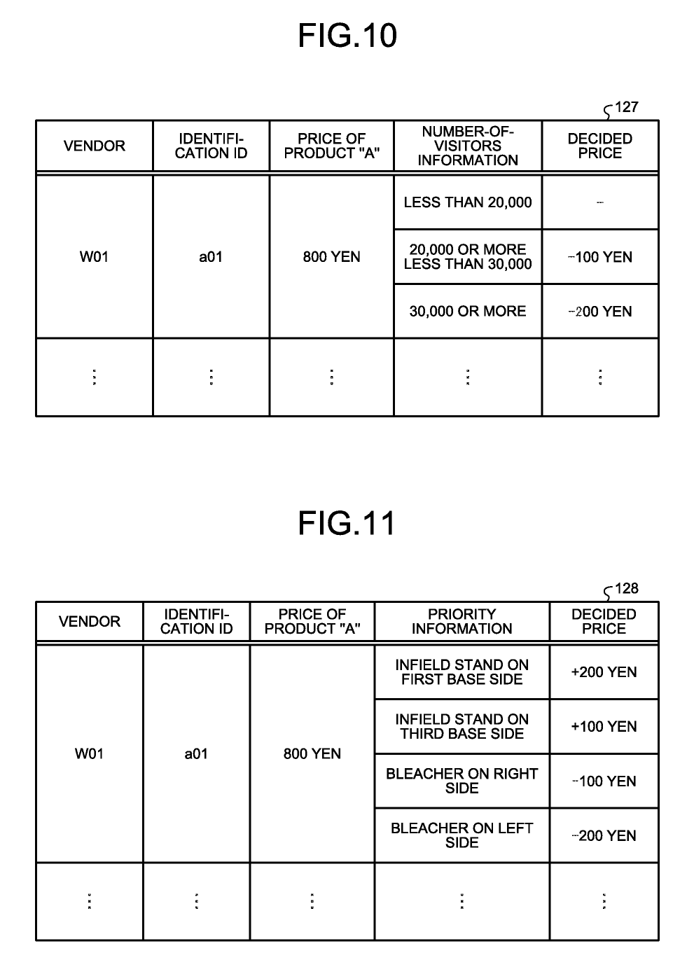

FIG. 10 is a diagram illustrating one example of number-of-visitors information that is stored in the number-of-visitors information database 127 according to the embodiment. In the example depicted in FIG. 10, information including items such as “vendor”, “identification ID”, “price of product A”, “number-of-visitors information”, and “decided price” is stored.

The “number-of-visitors information” is information that indicates the number of visitors to the baseball stadium 200. The number of visitors is, for example, the number of visitors at the start of a game.

The “decided price” of the number-of-visitors information database 127 is information on a price of the product A that is decided in accordance with the number of visitors. For example, when the number of visitors at the start of a game is less than 20000 and the user U01 purchases the “product A” from the vendor W01, a price of the product A to be sold on the spot by the vendor W01, which is decided in association with the identification ID “a01”, remains “1000 yen”. When the number of visitors at the start of a game is 20000 or more and less than 30000 and the user U01 purchases the “product A” from the vendor W01, a price obtained by subtracting “100 yen” from the price (“1000 yen”) of the product A to be sold on the spot by the vendor W01, which is decided in association with the identification ID “a01”, is a “decided price”. When the number of visitors at the start of a game is 30000 or more and the user U01 purchases the “product A” from the vendor W01, a price obtained by subtracting “200 yen” from the price (“1000 yen”) of the product A to be sold on the spot by the vendor W01, which is decided in association with the identification ID “a01”, is a “decided price”.

The priority information database 128 is a database that stores therein information indicating priority orders of spectator seats in the baseball stadium 200.

FIG. 11 is a diagram illustrating one example of the priority information that is stored in the priority information database 128 according to the embodiment. In the example depicted in FIG. 11, information including items such as “vendor”, “identification ID”, “price of product A”, “priority information”, and “decided price” is stored.

The “priority information” is information that indicates the priority order of a spectator seat in the baseball stadium 200. Specifically, for example, “infield stand on first base side”, “infield stand on third base side”, “bleacher on right side”, and “bleacher on left side” are prioritized in this order.

The “decided price” of the priority information database 128 is information on a price of the product A that is decided in accordance with a priority of a spectator seat. For example, when the user U01 sitting in “infield stand on first base side” purchases the “product A” from the vendor W01, a price obtained by adding “200 yen” to the price (“1000 yen”) of the product A to be sold on the spot by the vendor W01, which is decided in association with the identification ID “a01”, is a “decided price”. When the user U01 sitting in “bleacher on left side” purchases the “product A” from the vendor W01, a price obtained by subtracting “200 yen” from the price (“1000 yen”) of the product A to be sold on the spot by the vendor W01, which is decided in association with the identification ID “a01”, is a “decided price”. The information processing apparatus 100 acquires positional information of the user terminal 10 carried by the user U01 so as to specify in which seat the user U01 is sitting in the baseball stadium 200.

The game information database 129 is a database that stores therein information indicating a situation of baseball game in the baseball stadium 200.

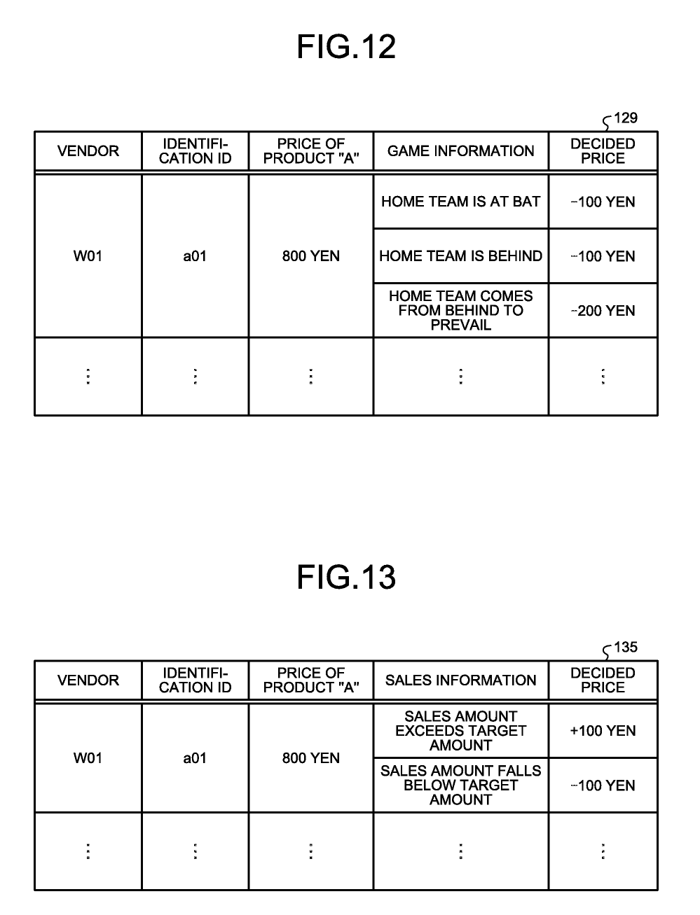

FIG. 12 is a diagram illustrating one example of game information that is stored in the game information database 129 according to the embodiment. In the example depicted in FIG. 12, information including items such as “vendor”, “identification ID”, “price of product A”, “game information”, and “decided price” is stored.

The “game information” is information that indicates a game situation of baseball played in the baseball stadium 200. Specifically, for example, the “game information” indicates a real-time game situation such as “home team is at bat”, “home team is behind”, and “home team comes from behind to prevail”.

The “decided price” of the game information database 129 is information on a price of the product A that is decided in accordance with a baseball-game situation. For example, when the user U01 purchases the “product A” from the vendor W01 in a situation of “home team is at bat” or “home team is behind”, a price obtained by subtracting “100 yen” from the price (“1000 yen”) of the product A to be sold on the spot by the vendor W01, which is decided in association with the identification ID “a01”, is a “decided price”. When the user U01 purchases the “product A” from the vendor W01 in a situation of “home team comes from behind to prevail”, a price obtained by subtracting “200 yen” from the price (“1000 yen”) of the product A to be sold on the spot by the vendor W01, which is decided in association with the identification ID “a01”, is a “decided price”.

The sales information database 135 is a database that stores therein sales information indicating totalized sales of the product to be sold by each of the vendors in the baseball stadium 200.

FIG. 13 is a diagram illustrating one example of sales information that is stored in the sales information database 135 according to the embodiment. In the example depicted in FIG. 13, information including items such as “vendor”, “identification ID”, “price of product A”, “sales information”, and “decided price” is stored.

The “sales information” is information that indicates totalized sales of the product A sold by each of the vendors W01, W02, etc. in the baseball stadium 200. Specifically, the “sales information” is information on whether a real-time totalized sales amount exceeds or falls below a predetermined target amount.

The “decided price” of the sales information database 135 is information on a price of the product A that is decided in accordance with the totalized sales of the product A sold by each of the vendors W01, W02, etc. in the baseball stadium 200. For example, when the totalized sales amount exceeds a predetermined target amount at a predetermined time point, a price obtained by adding “100 yen” to the price (“1000 yen”) of the product A to be sold on the spot by the vendor W01, which is decided in association with the identification ID “a01”, is a “decided price”. When the totalized sales amount falls below the predetermined target amount at the predetermined time point, or when the totalized sales amount is going to fall below the predetermined target amount at the predetermined time point, a price obtained by subtracting “100 yen” from the price (“1000 yen”) of the product A to be sold on the spot by the vendor W01, which is decided in association with the identification ID “a01”, is a “decided price”.

Returning to FIG. 3, the control unit 130 is a controller that is realized by executing various programs (one example of information processing programs), which are stored in an inner storage of the information processing apparatus 100, by using a storage area such as an RAM as a work region, which are instructed by, for example, a Central Processing Unit (CPU), a Micro Processing Unit (MPU), an Application Specific Integrated Circuit (ASIC), a Field Programmable Gate Array (FPGA), etc. In The example illustrated in FIG. 3, the control unit 130 includes a reception unit 131, a decision unit 132, a purchase processing unit 133, and a transmitting unit 134.

The reception unit 131 receives from the user terminal 10 an order request, including information on a moving body making an on-the-spot sale, for a product to be sold in the on-the-spot sale. Specifically, the reception unit 131 receives, from the user terminal 10, an order request that includes identification information provided to corresponding one of the vendors W01, W02, etc. The reception unit 131 stores the identification information included in the received order request in the above-mentioned moving-body information database 122.

The reception unit 131 receives, from the user terminal 10, an order request including positional information where the corresponding one of the vendors W01, W02, etc. preforms an on-the-spot sale. The reception unit 131 stores, in the above-mentioned positional information database 123, the positional information included in the received order request.

The reception unit 131 receives, from the user terminal 10, an order request including time point information that indicates a purchase time point of a product from each of the vendors W01, W02, etc. The reception unit 131 stores, in the above-mentioned time information database 124, the time point information included in the received order request. In a case of an order request not including the time point information, the reception unit 131 measures a time point when receiving the order request from the user terminal 10, and stores the measured time point in the time information database 124.

The reception unit 131 receives, from the user terminals 10, an order request including count information that indicates a count of purchase times of the product from each of the vendors W01, W02, etc. The reception unit 131 stores, in the above-mentioned count information database 125, count information included in the received order request. In a case of an order request not including the count information, the reception unit 131 counts reception times of order requests transmitted from the user terminal 10, and stores the counted number of the order requests in the count information database 125.

The decision unit 132 compares the identification information included in the received order request with identification IDs of the vendors W01, W02, etc. stored in the moving-body information database 122, and decides a price of the product A, which corresponds to the matched identification ID.

The decision unit 132 decides a price of the product A in accordance with the identification information included in the order request, and then further decides a price of the product A in accordance with positional information where the vendor makes the on-the-spot sale. Specifically, the decision unit 132 decides, in accordance with the positional information stored in the positional information database 123 where a vendor makes an on-the-spot sale, a price obtained by adding or subtracting a predetermined price to or from the price of the product A to be sold on the spot by the vendor, decided on the basis of identification information.

The decision unit 132 decides a price of the product A in accordance with identification information included in the order request, and then further decides a price of the product A in accordance with a time point when the product A is purchased from a vendor. Specifically, the decision unit 132 decides, in accordance with time point information when the product A is purchased from a vendor stored in the time information database 124, a price obtained by adding or subtracting a predetermined price to or from the price of the product A to be sold on the spot by the vendor, decided on the basis of identification information.

The decision unit 132 decides a price of the product A in accordance with identification information included in the order request, and then further decides a price of the product A in accordance with count information on the product A purchased from the vendor. Specifically, the decision unit 132 decides, in accordance with count information of the product A purchased from a vendor stored in the count information database 125, a price obtained by adding or subtracting a predetermined price to or from the price of the product A to be sold on the spot by the vendor, decided on the basis of identification information.

The decision unit 132 decides a price of the product A in accordance with identification information included in an order request, and then further decides a price of the product A in accordance with popularity information of the vendor. Specifically, the decision unit 132 decides, in accordance with popularity information of a vendor stored in the popularity information database 126, a price obtained by adding or subtracting a predetermined price to or from the price of the product A to be sold on the spot by the vendor, decided on the basis of identification information.

The decision unit 132 decides a price of the product A in accordance with identification information included in an order request, and then further decides a price of the product A in accordance with number-of-visitors information of a stadium at a game start. Specifically, the decision unit 132 decides, in accordance with the number-of-visitors information of the baseball stadium 200 stored in the number-of-visitors information database 127, a price obtained by adding or subtracting a predetermined price to or from the price of the product A to be sold on the spot by the vendor, decided on the basis of identification information.

The decision unit 132 decides a price of the product A in accordance with identification information included in an order request, and then further decides a price of the product A in accordance with priority information of a spectator seat in the stadium. Specifically, the decision unit 132 decides, in accordance with priority information of a spectator seat in the baseball stadium 200 stored in the priority information database 128, a price obtained by adding or subtracting a predetermined price to or from the price of the product A to be sold on the spot by the vendor, decided on the basis of identification information.

The decision unit 132 decides a price of the product A in accordance with identification information included in an order request, and then further decides a price of the product A in accordance with game information that indicates a game situation of a played sport. Specifically, the decision unit 132 decides, in accordance with game information on a game played in the baseball stadium 200 stored in the game information database 129, a price obtained by adding or subtracting a predetermined price to or from the price of the product A to be sold on the spot by the vendor, decided on the basis of identification.

The decision unit 132 decides a price of the product A in accordance with identification information included in an order request, and then further decides, in accordance with totalized sales of the product A sold by each of the vendors in the baseball stadium 200, a price of the product A to be sold on the spot by the corresponding vendor. Specifically, the decision unit 132 decides, in accordance with sales information stored in the sales information database 135, a price obtained by adding or subtracting a predetermined price to or from a price of the product A to be sold on the spot by the vendor, decided on the basis of identification information.

The purchase processing unit 133 executes a payment process for the product A on an e-commerce site on the basis of approval information for approving the purchase of the product A, which is received by the reception unit 131.

The transmitting unit 134 transmits, via a network, a price of the product A decided by the decision unit 132 to the user terminal 10. When the purchase processing unit 133 executes the payment process, the transmitting unit 134 transmits, via a network, payment completion information to the user terminal 10.

4. One Example of Actions and Effects of Information Processing

Next, contents of information processing to be executed by the processing units 131 to 134 will be explained with reference to FIG. 14. FIG. 14 is a sequence diagram depicting one example of information processing to be executed by the information processing system 1 according to the embodiment.

As illustrated in FIG. 14, the application controlling unit 23 included in the user terminal 10 starts up, in response to an operation performed by the user U01, application for executing a purchase process for the product A (Step S101). The user U01 summons, for example, the vendor W01 that is the closest to a seat of the user U01 among from the vendors W01, W02, etc. that make on-the-spot sales of the product A in the baseball stadium 200. Subsequently, the image capturing unit 14 included in the user terminal 10 reads the identification information 300 provided to the vendor W01 (Step S102).

The transmitting unit 27 of the user terminal 10 transmits, via a network, an order request for the product A including information on the vendor W01, to the information processing apparatus 100 (Step S103).

Subsequently, the reception unit 131 of the information processing apparatus 100 receives the order request transmitted from the user terminal 10 (Step S104). When receiving the order request transmitted from the user terminal 10, the reception unit 131 stores, in the storage 120, information on the vendor W01, which is included in the order request.

Next, the decision unit 132 of the information processing apparatus 100 decides a price of the product A in accordance with the information on the vendor W01 (Step S105). Specifically, when the information on the vendor W01 included in the order request is only the identification information 300 provided to the vendor W01, the decision unit 132 decides, in accordance with an identification ID corresponding to the identification information 300 provided to the vendor W01, a price of the product A to be sold on the spot by the vendor W01.

When the information on the vendor W01 included in the order request is the identification information 300 provided to the vendor W01 and positional information where the vendor W01 makes an on-the-spot sale, the decision unit 132 decides a price of the product A in accordance with the identification information 300, and then further decides a price of the product A to be sold on the spot by the vendor W01 in accordance with the positional information where the vendor W01 makes the on-the-spot sale.

When the information on the vendor W01 included in the order request is the identification information 300 provided to the vendor W01 and time point information that indicates a purchase time point of the product A from the vendor W01, the decision unit 132 decides a price of the product A in accordance with the identification information 300, and then further decides a price of the product A to be sold on the spot by the vendor W01 in accordance with the time point information when the product A is purchased from the vendor W01. When the order request does not include the time point information, the decision unit 132 decides, on the basis of the time information database 124 storing the time point at which a time point of a receipt of the order request from the user terminal 10 is measured, a price of the product A to be sold on the spot by the vendor W01 in accordance with the time point when the order request is made.

When the information on the vendor W01 included in the order request is the identification information 300 provided to the vendor W01 and count information indicating a count of purchase times of the product A from the vendor W01, the decision unit 132 decides a price of the product A in accordance with the identification information 300, and then further decides a price of the product A to be sold on the spot by the vendor W01 in accordance with the purchase count information of the product A of the vendor W01. When the order request does not include the count information, the decision unit 132 decides, on the basis of the count information database 125 that stores the number of order requests obtained by counting reception times of an order request transmitted from the user terminal 10, a price of the product A to be sold on the spot by the vendor W01 in accordance with the number of the order requests.

The information on the vendor W01 may include all kinds of information including the identification information 300 provided to the vendor W01, the positional information where the vendor W01 makes an on-the-spot sale, the time point information indicating a time point when the product A is purchased, and the count information that indicates a count of purchase times of the product A from the vendor W01. In this case, for example, information that is to be preferentially selected may be previously set among from the positional information, the time point information, and the count information; a price of the product A may be decided in accordance with the identification information 300; and a price of the product A to be sold on the spot by the vendor W01 may be further decided in accordance with the preferentially selected information.

The decision unit 132 may decide a price of the product A to be sold on the spot by the vendor W01 in accordance with the identification information 300 included in the order request, and then further may decide a price of the product A to be sold on the spot by the vendor W01 in accordance with the popularity information that indicates the popularity of the vendor W01.

The decision unit 132 may decide a price of the product A to be sold on the spot by the vendor W01 in accordance with the identification information 300 included in the order request, and then further may decide a price of the product A to be sold on the spot by the vendor W01 in accordance with the number-of-visitors information to the baseball stadium 200 at a game start.

The decision unit 132 may decide a price of the product A to be sold on the spot by the vendor W01 in accordance with the identification information 300 included in an order request, and then further may decide a price of the product A to be sold on the spot by the vendor W01 in accordance with a priority of a spectator seat of the user U01 in the baseball stadium 200.

The decision unit 132 may decide a price of the product A to be sold on the spot by the vendor W01 in accordance with the identification information 300 included in an order request, and then further may decide a price of the product A to be sold on the spot by the vendor W01 in accordance with game information of a game played in the baseball stadium 200.

The decision unit 132 may decide a price of the product A to be sold on the spot by the vendor W01 in accordance with the identification information 300 included in an order request, and then further may decide a price of the product A to be sold on the spot by the vendor W01 in accordance with totalized sales of the product A sold by each of the vendors W01, W02, etc. in the baseball stadium 200.

Subsequently, the transmitting unit 134 of the information processing apparatus 100 transmits to the user terminal 10, via a network, the price of the product A to be sold on the spot by the vendor W01 that is decided as described above by the decision unit 132 (Step S106).

When receiving the decided price of the product A to be sold on the spot by the vendor W01, which is transmitted from the information processing apparatus 100, the reception unit 26 of the user terminal 10 displays the decided price on the output unit 13 (Step S107). When being informed of the price of the product A to be sold on the spot by the vendor W01 from the above-mentioned display on the user terminal 10 and being going to purchase the product A, the user U01 depresses a displayed button of, for example, “approving purchase” that is displayed on the output unit 13 (Step S108).

When receiving an approval associated with the depression of the displayed button of “approving purchase”, the transmitting unit 27 of the user terminal 10 transmits, via a network, approval information to the information processing apparatus 100 (Step S109).

The reception unit 131 of the information processing apparatus 100 receives the approval information transmitted from the user terminal 10 (Step S110). The purchase processing unit 133 of the information processing apparatus 100 executes on an e-commerce site, on the basis of the received approval information, a payment process of the product A according to the approval information (Step S111).

Subsequently, when the purchase processing unit 133 executes the payment process, the transmitting unit 134 of the information processing apparatus 100 transmits, via a network, payment completion information to the user terminal 10 (Step S112).

When receiving the payment completion information transmitted from the information processing apparatus 100, the reception unit 26 of the user terminal 10 displays payment completion information on the output unit 13 (Step S113). The user U01 shows, to the vendor W01, the payment completion information displayed on the output unit 13, for example, and then the product A is delivered to the user U01 from the vendor W01 that has checked the display.

5. Modification

The above-mentioned information processing apparatus 100 executes a payment process for the product A to be sold on the spot by a vendor, the information processing apparatus 100 according to a modification executes not only the payment process for the product A but also a payment process of a tip (remuneration) for a service provided by the vendor. Hereinafter, this mode will be specifically explained.

The transmitting unit 134 of the information processing apparatus 100 according to the modification transmits to the user terminal 10, via a network, not only a decided price of the product A to be sold on the spot by a vendor, which is decided by the decision unit 132, but also information for processing for executing a process regarding payment of a remuneration for a service provided by the vendor.

When receiving a decided price and information for processing of the product A that are transmitted from the information processing apparatus 100, the reception unit 26 of the user terminal 10 displays, on the output unit 13, the decided price and the information for processing of the product A.

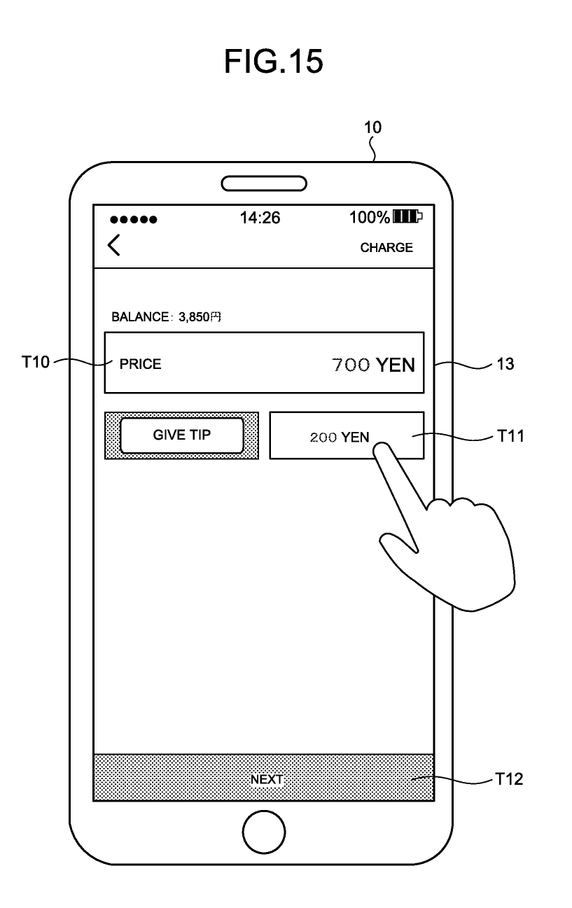

A case will be explained with reference to FIG. 15, in which the decided price and the information for processing of the product A, which are transmitted from the information processing apparatus 100, are displayed on the output unit 13 of the user terminal 10. FIG. 15 is a diagram illustrating one example of a display screen according to the modification of the embodiment.

As illustrated in FIG. 15, when the output unit 13 of the user terminal 10 receives the decided price and the information for processing of the product A that are transmitted from the information processing apparatus 100, the output unit 13 displays thereon a field T10 indicating the decided price of the product A to be sold on the spot by the vendor, an input field T11 to which an amount of remuneration to be paid to the vendor is to be input, and a displayed button T12 of “next” for proceeding to a purchase approval screen. The input field T11 according to the present embodiment into which an amount of remuneration to be paid to the vendor is to be input corresponds to the information for processing that is for executing the process for paying the remuneration for the service provided by the vendor.

In the example illustrated in FIG. 15, “700 yen” is displayed in the field T10 for indicating the decided price of the product A to be sold on the spot by the vendor W01, and “200 yen” is input to the input field T11 into which an amount of remuneration to be paid to the vendor W01 is to be input. The user U01 may select, in the input field T11, an amount of remuneration among from a plurality of previously-set amounts of remuneration that are different from one another, instead of inputting an arbitrary amount of remuneration to the input field T11.

When the user U01 inputs, to the input field T11, an amount of remuneration that is 0 yen or more and touches the displayed button T12 of “next”, a payment of the remuneration to the vendor W01 is fixed to proceed to a purchase approval screen.

When receiving an approval associated with a depression of the displayed button of “approving purchase”, the transmitting unit 27 of the user terminal 10 transmits, via a network, approval information to the information processing apparatus 100.

When the reception unit 131 receives the approval information, the purchase processing unit 133 of the information processing apparatus 100 executes on an e-commerce site, on the basis of the received approval information, a payment process for the product A and the remuneration that are associated with the approval information. In other words, the purchase processing unit 133 executes a process for paying both of the decided price “700 yen” of the product A and the amount of remuneration “200 yen” of the vendor W01 at a time.

On the other hand, when the user U01 inputs, to the input field T11, an amount of remuneration that is 0 yen and touches the displayed button T12 of “next”, no payment of the remuneration to the vendor W01 is fixed. In this case, the purchase processing unit 133 of the information processing apparatus 100 executes, on the e-commerce site, only the payment process for the product A associated with the approval information. In other words, the purchase processing unit 133 executes a process for paying only the decided price “700 yen” of the product A at a time.

As described above, the information processing apparatus 100 according to the modification executes not only the payment process for the product A but also the payment process for a tip (remuneration) for a service provided by the vendor so that the user is able to easily pay a tip to the vendor for his/her good service.

By employing the information processing apparatus 100 according to the modification, a vendor is able to get a tip so as to increase his/her sales amount, so that it is possible to improve his/her motivation for sales of the product A.

Although the purchase processing unit 133 of the above-mentioned information processing apparatus 100 according to the modification executes the settlement process for both of the decided price “700 yen” of the product A and the amount of remuneration “200 yen” of the vendor W01 at a time, the purchase processing unit 133 may execute a settlement process for the remuneration after executing a settlement process for the product A. In other words, the above-mentioned information processing apparatus 100 according to the modification may separately execute the settlement process for the product A and that for the remuneration.

In this case, the output unit 13 of the user terminal 10 displays an approval screen for approving a payment of the remuneration to the vendor, in addition to an approval screen for approving a purchase of the product A, for example. The transmitting unit 27 of the user terminal 10 transmits, to the information processing apparatus 100, approval information on the purchase of the product A associated with the approval executed on the approval screen for approving the purchase of the product A. The transmitting unit 27 of the user terminal 10 transmits, to the information processing apparatus 100, approval information on the payment of the remuneration to the vendor associated with the approval executed on the approval screen for approving the payment of the remuneration to the vendor.

When the reception unit 131 of the information processing apparatus 100 receives the approval information on the purchase of the product A, the purchase processing unit 133 executes a payment process for the product A. When the reception unit 131 receives the approval information on the payment of the remuneration to the vendor, the purchase processing unit 133 of the information processing apparatus 100 executes a payment process for the remuneration.

In the above-mentioned modification, the user U01 freely decides an amount of remuneration to be paid to the vendor W01; however not limited thereto, the amount of remuneration to be paid to the vendor W01 may be a fixed amount of money.

In this case, the transmitting unit 134 of the information processing apparatus 100 according to the modification transmits to the user terminal 10, via a network, not only a decided price of the product A, which is decided by the decision unit 132, to be sold on the spot by the vendor but also an amount of remuneration according to the vendor. The decision unit 132 of the information processing apparatus 100 decides, in accordance with the popularity of the vendor, the amount of remuneration to be paid to the vendor, for example.

When receiving a decided price of the product A and an amount of remuneration that are transmitted from the information processing apparatus 100, the reception unit 26 of the user terminal 10 displays, on the output unit 13, the decided price of the product A and the amount of remuneration.

6. Effects

As described above, the information processing apparatus 100 includes the reception unit 131, the decision unit 132, and the transmitting unit 134. The reception unit 131 receives from the user terminal 10 an order request, including information on a moving body that makes an on-the-spot sale, for a product to be sold at the on-the-spot sale. The decision unit 132 decides a price of the product in accordance with the information, received by the reception unit 131, on the moving body. The transmitting unit 134 transmits, to the user terminal 10, the price decided by the decision unit 132. Thus, the information processing apparatus 100 is capable of providing an additional service to an on-the-spot sale of a product, which is made by a moving body. In other words, the information processing apparatus 100 is capable of dynamically deciding a price of a product to be sold on the spot by a moving body.

The reception unit 131 of the information processing apparatus 100 receives, as the information on the moving body, an order request including identification information that identifies the moving body, and the decision unit 132 decides a price of the product in accordance with the identification information. Thus, the information processing apparatus 100 is capable of deciding a price of a product to be sold at an on-the-spot sale in accordance with identification information that identifies a moving body.

The information processing apparatus 100 further includes the storage 120 that stores therein popularity information indicating popularity of the moving body corresponding to the identification information, and the decision unit 132 decides a price of the product in accordance with the popularity information. Thus, the information processing apparatus 100 is capable of deciding a price of a product to be sold at an on-the-spot sale in accordance with the popularity of a moving body corresponding to identification information.

The storage 120 of the information processing apparatus 100 stores therein number-of-visitors information that indicates a number of visitors to an event site, and the decision unit 132 decides a price of the product in accordance with the number-of-visitors information. Thus, the information processing apparatus 100 is capable of deciding a price of a product to be sold at an on-the-spot sale in accordance with the number of visitors to an event site.

The storage 120 of the information processing apparatus 100 stores therein priority information that indicates priority orders of spectator seats in an event site, and the decision unit 132 decides a price of the product in accordance with the priority information. Thus, the information processing apparatus 100 is capable of deciding a price of a product to be sold at an on-the-spot sale in accordance with a priority order of a spectator seat in an event site.

The storage 120 of the information processing apparatus 100 stores therein game information that indicates a game situation of a sport being played, and the decision unit 132 decides a price of the product in accordance with the game information. Thus, the information processing apparatus 100 is capable of deciding a price of a product to be sold at an on-the-spot sale in accordance with a game situation of a sport being played.

The storage 120 of the information processing apparatus 100 stores therein sales information that indicates totalized sales of the product sold by the moving body in an event site, and the decision unit 132 decides a price of the product in accordance with the sales information. Thus, the information processing apparatus 100 is capable of deciding a price of a product to be sold at an on-the-spot sale in accordance with totalized sales of the product sold by a moving body in an event site. For example, when the totalized sales amount is going to fall below a predetermined target amount, the sale is able to be facilitated by decreasing a price of a product to be sold by the moving body.

The reception unit 131 of the information processing apparatus 100 receives, as the information on the moving body, an order request including positional information on a position where the moving body makes the on-the-spot sale, and the decision unit 132 decides a price of the product in accordance with the positional information. Thus, the information processing apparatus 100 is capable of deciding a price of a product to be sold at an on-the-spot sale in accordance with a position where the moving body makes the on-the-spot sale.

The decision unit 132 of the information processing apparatus 100 decides a price of the product in accordance with a time point at which the order request is made. Thus, the information processing apparatus 100 is capable of deciding a price of a product to be sold at an on-the-spot sale in accordance with a time point at which its order request is made.

The decision unit 132 of the information processing apparatus 100 decides a price of the product in accordance with a count of times at each of which the order request is made. Thus, the information processing apparatus 100 is capable of deciding a price of a product to be sold at an on-the-spot sale in accordance with the number of times at each of which the order request is made.

The transmitting unit 134 of the information processing apparatus 100 transmits to the user terminal 10, in addition to the price decided by the decision unit 132, process information for executing a payment process of a remuneration for a service provided by the moving body. Thus, the information processing apparatus 100 executes a payment process of a tip (remuneration) for a service provided by a vendor in addition to a payment process of a price of a product, so that the user is able to easily pay a tip to the vendor for his/her good service.

7. Hardware Configuration

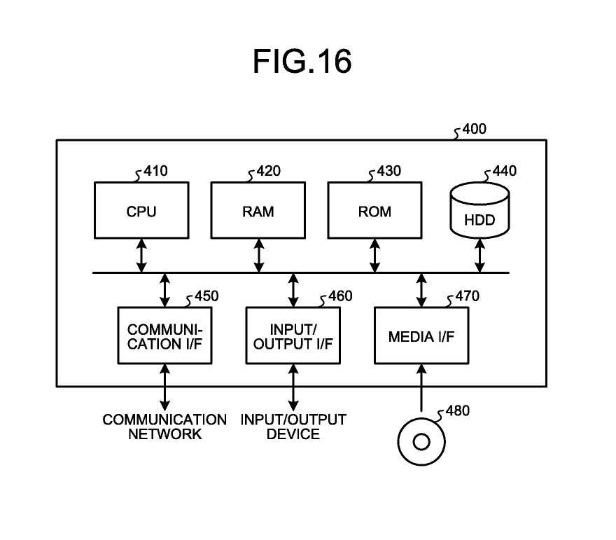

The information processing apparatus 100 according to the embodiment is realized by using, for example, a computer 400 having a configuration illustrated in FIG. 16. Hereinafter, the information processing apparatus 100 is exemplified. FIG. 16 is a diagram illustrating one example of a hardware configuration of the computer 400 that realizes functions of the information processing apparatus 100. The computer 400 includes a CPU 410, a RAM 420, a ROM 430, an HDD 440, a communication interface (I/F) 450, an input/output interface (I/F) 460, and a media interface (I/F) 470.

The CPU 410 operates on the basis of programs stored in the ROM 430 or the HDD 440, so as to control various units. The ROM 430 stores therein a boot program that is to be executed by the CPU 410 at a start-up of the computer 400, programs that depend on hardware of the computer 400, and the like.

The HDD 440 stores therein programs to be executed by the CPU 410, data to be used by the programs, and the like. The communication interface 450 receives, via a network, data from another device and transmits the data to the CPU 410, and further transmits, via a network, data generated by the CPU 410 to another device.

The CPU 410 controls, via the input/output interface 460, output devices such as a display and a printer, and input devices such as a keyboard and a mouse. The CPU 410 acquires, via the input/output interface 460, data from the input devices. The CPU 410 outputs, via the input/output interface 460, data generated thereby to the output devices.

The media interface 470 reads out a program or data stored in a recording medium 480, and provides it to the CPU 410 via the RAM 420. The CPU 410 loads the provided program from the recording medium 480 onto the RAM 420 via the media interface 470, and executes the loaded program. The recording medium 480 may be an optical recording medium such as a Digital Versatile Disk (DVD) and a Phase change rewritable Disk (PD), a magnetooptical recording medium such as a Magneto Optical disk (MO), a tape medium, a magnetic recording medium, and a semiconductor memory.

For example, when the computer 400 functions as the information processing apparatus 100 according to the embodiment, the CPU 410 of the computer 400 executes a program, which is loaded on the RAM 420, so as to realize a function of the control unit 130. The HDD 440 stores therein data that is stored in the storage 120. The CPU 410 of the computer 400 reads from the recording medium 480 and executes these read programs; however, these programs may be acquired from another device via a network in another example.

8. Others

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

In the information processing apparatus 100 according to the above-mentioned embodiment, a price of the product A is decided in accordance with the identification information included in the order request, and then a price of the product A is further decided in accordance with information on any one of the positional information where a vendor makes an on-the-spot sale, the time point information indicating a time point at which the product A is purchased from the vendor, and the count information indicating a count of purchase times of the product A from the vendor; however, not limited thereto.

As another embodiment, the information processing apparatus 100 may receive, from the user terminal 10, an order request including only positional information where a vendor makes an on-the-spot sale, and may decide a price of the product A to be sold on the spot by the vendor in accordance with the positional information included in the received order request.

The information processing apparatus 100 may receive, from the user terminal 10, an order request including only time point information indicating a time point at which the product A is purchased from a vendor, and may decide a price of the product A to be sold on the spot by the vendor in accordance with the time point information included in the received order request.

The information processing apparatus 100 may receive, from the user terminal 10, an order request including only count information indicating a count of purchase times of the product A from a vendor, and may decide a price of the product A to be sold on the spot by the vendor in accordance with the count information included in the received order request.

The information processing apparatus 100 according to the above-mentioned embodiment decides a price of the product A to be sold on the spot by a vendor in accordance with identification information included in an order request, and then further decides a price of the product A to be sold on the spot by the vendor in accordance with popularity information that indicates the popularity of the vendor; however, not limited thereto.

As another embodiment, the information processing apparatus 100 may decide a price of the product A to be sold on the spot by a vendor in accordance with positional information included in an order request, and then may further decide a price of the product A to be sold on the spot by the vendor in accordance with popularity information that indicates the popularity of the vendor.

The information processing apparatus 100 may decide a price of the product A to be sold on the spot by a vendor in accordance with time point information included in an order request, and then may further decide a price of the product A to be sold on the spot by the vendor in accordance with popularity information that indicates the popularity of the vendor.

The information processing apparatus 100 may decide a price of the product A to be sold on the spot by a vendor in accordance with count information included in an order request, and then may further decide a price of the product A to be sold on the spot by the vendor in accordance with popularity information that indicates the popularity of the vendor.

The user terminal 10 according to the above-mentioned embodiment reads out identification information that is provided to each of the vendors W01, W02, etc. by using a camera function provided in the user terminal 10, and transmits, to the information processing apparatus 100, an order request including the read identification information; however, not limited thereto.

As another embodiment, the user terminal 10 may read out, by using the camera function provided in the user terminal 10, a bar code provided to a product to be sold on the spot by each of the vendors W01, W02, etc., and may transmit an order request including product information such as the bar code to the information processing apparatus 100. The decision unit 132 of the information processing apparatus 100 may decide a price of the product in accordance with the product information of the product to be sold on the spot by each of the vendors W01, W02, etc.

In the above-mentioned embodiment, the case has been explained in which the user U01 spectating in an infield stand of the baseball stadium 200 purchases, by using the user terminal 10 carried by the user U01, the product A to be sold on the spot by the vendors W01, W02, etc.; however, not limited to the baseball stadium 200. For example, also in a case where a product is purchased from a vendor that makes on-the-spot sales in an event site for holding an event, such as a stadium and a concert hall, a price of the product to be sold on the spot by the vendor may be dynamically decided as described above.

In the above-mentioned embodiment, a vendor (sales person) is exemplified as a moving body; however, the moving body is not limited to a person, and a robot, a vehicle, etc. for on-the-spot sales are able to realize the above-mentioned embodiment. In this case, for example, the identification information is provided to the robot and the vehicle.

Among the processes having been explained in the above embodiment, all or a part of the processes, which are explained to be automatically executed, may be manually executed. Alternatively, among the processes having been explained in the embodiment, all or a part of the processes, which are explained to be manually executed, may be automatically executed by using a well-known method. Moreover, any of the processing procedures, the specific appellations, and the information including various data and parameters, which are described in the specification and the accompanying drawings, may be arbitrarily changed if not otherwise specified. For example, the various kinds of information depicted in the accompanying drawings is not limited thereto.

The illustrated components of the devices are functionally conceptual, and thus they are not to be physically configured as illustrated in the drawings. Specific forms of distribution and integration of the configuration elements of the illustrated devices are not limited to those illustrated in the drawings, and all or some of the devices can be configured by separating or integrating the apparatus functionally or physically in any unit, according to various types of loads, the status of use, etc.

In the embodiment, although the information processing apparatus 100 realizes/executes functions/actions of information processing, the user terminal 10 may be configured to have a part of the functions/actions of the information processing of the information processing apparatus 100, so as to realize/execute the part of the functions/actions of the information processing. The information processing apparatus 100 may be configured to have a part of functions/actions of information processing of the user terminal 10, so as to realize/execute the part of the functions/actions of the information processing.

Any of the processes described in the above-mentioned embodiments may be incorporated with each other within a consistent range with respect to processing details.

A configuration of the above-mentioned information processing apparatus 100 may be flexibly modified. For example, the information processing apparatus 100 may be realized by using a plurality of server computers, or realized by invoking, depending on function, an external platform etc. by using an Application Programming Interface (API), network computing, etc.

The above “section, module, or unit” may be replaced by “means”, “circuit”, or the like. For example, a decision unit may be replaced by any of a decision means and a decision circuit.

According to one aspect of the embodiment, it is possible to provide an additional service to an on-the-spot sale of a product, which is made by a moving body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a reception unit that receives from a user terminal an order request, including information on a moving body that makes an on-the-spot sale, for a product to be sold at the on-the-spot sale;
a decision unit that decides a price of the product in accordance with the information, received by the reception unit, on the moving body; and
a transmitting unit that transmits, to the user terminal, the price decided by the decision unit.

2. The information processing apparatus according to claim 1, wherein
the reception unit receives, as the information on the moving body, an order request including identification information that identifies the moving body, and
the decision unit decides a price of the product in accordance with the identification information.

3. The information processing apparatus according to claim 2, further comprising:
a storage that stores therein popularity information indicating popularity of the moving body corresponding to the identification information, wherein
the decision unit decides a price of the product in accordance with the popularity information.

4. The information processing apparatus according to claim 3, wherein
the storage further stores therein number-of-visitors information that indicates a number of visitors to an event site, and
the decision unit decides a price of the product in accordance with the number-of-visitors information.

5. The information processing apparatus according to claim 3, wherein
the storage further stores therein priority information that indicates priority orders of spectator seats in an event site, and
the decision unit decides a price of the product in accordance with the priority information.

6. The information processing apparatus according to claim 3, wherein
the storage further stores therein game information that indicates a game situation of a sport being played, and
the decision unit decides a price of the product in accordance with the game information.

7. The information processing apparatus according to claim 3, wherein
the storage further stores therein sales information that indicates totalized sales of the product sold by the moving body in an event site, and
the decision unit decides a price of the product in accordance with the sales information.

8. The information processing apparatus according to claim 1, wherein
the reception unit receives, as the information on the moving body, an order request including positional information on a position where the moving body makes the on-the-spot sale, and
the decision unit decides a price of the product in accordance with the positional information.

9. The information processing apparatus according to claim 1, wherein
the decision unit decides a price of the product in accordance with a time point at which the order request is made.

10. The information processing apparatus according to claim 1, wherein
the decision unit decides a price of the product in accordance with a count of times at each of which the order request is made.

11. The information processing apparatus according to claim 1, wherein
the transmitting unit transmits to the user terminal, in addition to the price decided by the decision unit, process information for executing a payment process of a remuneration for a service provided by the moving body.

12. An information processing method to be executed by a computer, the method comprising:
receiving from a user terminal an order request, including information on a moving body that makes an on-the-spot sale, for a product to be sold at the on-the-spot sale;
deciding a price of the product in accordance with the information, received in the receiving, on the moving body; and
transmitting, to the user terminal, the price decided in the deciding.

13. A non-transitory computer-readable recording medium having stored therein an information processing program that causes a computer to execute a process comprising:
receiving from a user terminal an order request, including information on a moving body that makes an on-the-spot sale, for a product to be sold at the on-the-spot sale;
deciding a price of the product in accordance with the information, received in the receiving, on the moving body; and
transmitting, to the user terminal, the price decided in the deciding.
